(19) United States
(12) Patent Application Publication
(10) Pub. No.: US 2008/0102012 A1
(43) Pub. Date: May 1, 2008

(54) Phosphor

(75) Inventor: Hajime Saito, Tenri-shi (JP)

Correspondence Address: BIRCH STEWART KOLASCH & BIRCH, PO BOX 747, FALLS CHURCH, VA, 22040-0747, US

(73) Assignee: SHARP KABUSHIKI KAISHA

(21) Appl. No.: 11/905,690

(22) Filed: Oct. 3, 2007

(30) Foreign Application Priority Data
Oct. 4, 2006 (JP) 2006-272836(P)

(51) Int. Cl. C01F 17/00

(52) U.S. Cl. 423/263

(57) ABSTRACT

A phosphor with oxide crystal containing at least first metal ions and second metal ions as a base is provided. The first metal ions include at least one type of valence III metal ions selected from the group consisting of aluminium, gallium, vanadium, scandium, antimony and indium. The valence III metal ions are partially substituted with at least one type of valence III rare earth ions qualified as a luminous body. The second metal ions are metal ions other than valence II metal ions. The phosphor has the luminescent quantum efficiency improved since the inversion symmetry of the crystal field is intentionally destroyed to increase the transition intensity.

This nonprovisional application is based on Japanese Patent Application No. 2006-272836 filed with the Japan Patent Office on Oct. 4, 2006, the entire contents of which are hereby incorporated by reference.

### BACKGROUND OF THE INVENTION

1. Field of the Invention

The present invention relates to a new phosphor, particularly a phosphor having the luminescent quantum efficiency improved by destroying the inversion symmetry of the crystal field to increase the transition intensity.

2. Description of the Background Art

A phosphor is based on an inorganic and/or organic complex compound, having element ions corresponding to a luminous body added to the base. When an electromagnetic wave qualified as the excitation source is applied thereto, the excitation energy is converted into light at the luminous body to be emitted. The electromagnetic wave qualified as the excitation source includes light, electronic beams, X-rays and the like. Particularly those emitting ultraviolet radiation of 400 nm or below to achieve visible light from the phosphor have become widely available.

For the luminous body, ions of rare earth elements and transition elements are employed. The type of element and ionic valence are selected appropriately depending upon the desired properties such as the radiation wavelength, the spectrum bandwidth and the like. In particular, the rare earth element is in common use as the luminous body in various phosphorous materials by virtue of stability in the absorption and radiation transition, the high transition intensity, the high luminescent quantum efficiency, and the like, as compared to the transition element.

Among the various processes of the absorption and radiation transition of the rare earth element, the transition between the split 4fⁿ orbital levels has the feature of being less susceptible to the influence of the base material and allowing selective excitation light absorption and light emission. Lanthanides having at least one electron at the 4f orbit, and that can cause absorption and radiation transition (14 elements from Ce to Lu), are defined hereinafter as rare earth elements qualified as a luminous body, excluding Sc, Y and La from the rare earth elements.

It is to be noted that the 4fⁿ orbital level transition of a rare earth element is transition between the same parity, and transition by an electric dipole is essentially prohibited. However, if the inversion symmetry of the crystal field generated by the base is destroyed, the transition intensity will increase significantly since a state of having a parity different from that of 4fⁿ is included. In view of the foregoing, phosphors having an effective luminescent quantum efficiency, taking advantage of the 4fⁿ orbital level transition, were adapted to practical use.

For the purpose of achieving a unique 4fⁿ orbital level transition in the rare earth elements such as Sm and Eu, the rare earth element must interact with the crystal field of the base in the valence III ion state. In order to realize such a configuration, the method of activating rare earth ions by lattice-substitution of metal ions having an ion radius substantially equal to that of valence III rare earth ions and of the same valence number included into the component of the base was employed in the procedure of selecting the phosphor material.

In the Y₂O₃:Eu³⁺ red phosphor, for example, Eu having a valence III ion radius of 0.95 Å is readily lattice-substituted with Y since the valence III ion radius of Y is 0.90 Å. In view of the foregoing, many phosphor based on oxides containing Y and La of valence III as the component elements are disclosed for a phosphor utilizing 4fⁿ orbital level transition of rare earth ions (for example, Japanese Patent Laying-Open No. 64-006086).

Similarly, in the case where light emission utilizing the transition between 4f and 5d orbital levels is to be achieved, there are examples employing valence II ions of Sm and Eu. The aforementioned publication of Japanese Patent Laying-Open No. 64-006086 discloses a phosphor having Sr, Mg and Ca of valence II, qualified as the component element of the base, lattice-substituted.

Improvement of the luminescent quantum efficiency of a phosphor has been made mainly from the standpoint of suppressing phonon loss and/or obviating concentration/temperature quenching. Few approaches have been made from the standpoint of increasing the transition intensity of absorption radiation, and no significant advantage has yet been obtained therefrom.

In view of the transition mechanism between the 4fⁿ orbital levels transition set forth above, significantly destroying the inversion symmetry of the crystal field can be thought of for the sake of increasing the transition intensity. However, the crystal field affecting the rare earth ions are only few atoms in the neighborhood. It was extremely difficult to intentionally suppress such a small crystal field.

### SUMMARY OF THE INVENTION

In view of the foregoing, an object of the present invention is to provide a phosphor having the luminescent quantum efficiency improved by intentionally destroying the inversion symmetry of the crystal field to increase the transition intensity.

The present invention is directed to a phosphor with oxide crystal containing at least first metal ions and second metal ions as a base, wherein the first metal ions include at least one type of valence III metal ions selected from the group consisting of aluminium, gallium, vanadium, scandium, antimony and indium. The valence III metal ions are partially substituted with at least one type of valence III rare earth ions qualified as a luminous body. The second metal ions are metal ions other than valence II metal ions.

The second metal ions preferably include metal ions of valence I, valence IV or valence V.

The valence III rare earth ions are preferably at least one type of rare earth ions selected from the group consisting of praseodymium, neodymium, samarium, europium, terbium, dysprosium, holmium, erbium, thulium, and yttribium.

The occupying ratio of any one of europium, samarium, terbium, and thulium in the valence III rare earth ions is preferably at least 50% to the total number of atoms in the valence III rare earth ions.

In accordance with the present invention, a phosphor having the luminescent quantum efficiency improved can be provided by intentionally destroying the inversion symmetry of the crystal field to increase the transition intensity.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 represents the emission spectrum of a phosphor obtained by Example 1.

FIG. 2 represents an emission spectrum of a phosphor obtained by Example 2 and Example 4.

FIG. 3 represents an emission spectrum of a phosphor obtained by Example 3.

### DESCRIPTION OF THE PREFERRED EMBODIMENTS

A phosphor of the present invention includes a base of oxide crystal, including at least valence III metal ions identified as first metal ions, and second metal ions. The phosphor also includes at least one type of valence III rare earth ions, qualified as a luminous body, substituting a portion of the valence III metal ions.

First Metal Ions The ion radius of the valence III metal ions included in the base is preferably smaller than the ion radius of the valence III rare earth ions qualified as the luminous body. By employing valence III rare earth ions as a luminous body with respect to the base crystal including the valence III metal ions, the lattice site of valence III metal ions is readily substituted with valence III rare earth ions. Further, by employing valence III metal ions having an ion radius smaller than that of the valence III rare earth ions, the crystal in the neighborhood of the sites substituted with rare earth ions will be slightly distorted. The inversion symmetry of the crystal field is destroyed, whereby the transition intensity is increased.

The following Table 1 represents specific examples of the types of ions as well as their valence III ion radius (coordination number 6) that can be employed as the first metal ion in the base, and specific examples of the types of rare earth ions that can be employed for the luminous body as well as their valence III ion radius (coordination number 6).

TABLE 1

| | |
|---|---|
| Base | Luminous Body |

| | Ion Radius | | Ion Radius |
|---|---|---|---|
| Ion Type | (Å) | Ion Type | (Å) |
| Al³⁺ | 0.54 | Ce³⁺ | 1.01 |
| Ga³⁺ | 0.62 | Pr³⁺ | 0.99 |
| V³⁺ | 0.64 | Nd³⁺ | 0.98 |
| Sc³⁺ | 0.75 | Sm³⁺ | 0.96 |
| Sb³⁺ | 0.76 | Eu³⁺ | 0.95 |
| In³⁺ | 0.80 | Gd³⁺ | 0.94 |
| Y³⁺ | 0.90 | Tb³⁺ | 0.92 |
| Bi³⁺ | 1.03 | Dy³⁺ | 0.91 |
| La³⁺ | 1.03 | Ho³⁺ | 0.90 |
| | | Er³⁺ | 0.89 |
| | | Tm³⁺ | 0.88 |
| | | Yb³⁺ | 0.87 |

As shown in Table 1, the valence III ions of aluminium (Al), gallium (Ga), vanadium (V), scandium (Sc), antimony (Sb) and indium (In) have an ion radius smaller than the valence III ion radius of the rare earth ions corresponding to a luminous body, and can be preferably employed as the first metal ions constituting the base. One or more types can be selected from the metal ions of Al, Ga, V, Sc, Sb and In.

If valence III metal ions having a valence III ion radius smaller than that of Al is employed for the base, substitution with valence III rare earth ions is rendered difficult, and a tendency of reduction in the luminescent quantum efficiency is noted by the excessive distortion of the lattice. If yttrium (Y), bismuth (Bi), lutetium (Lu) or lanthanum (La) having a valence III ion radius substantially equal to that of valence III rare earth ions is included as the element constituting the base, almost no crystal distortion will occur, although the lattice is substituted in priority with valence III rare earth ions. Accordingly, the transition intensity can not be increased.

Valence III Rare Earth Ions

Specific examples of valence III rare earth ions employed as a luminous body are valence III ions such as cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb) and lutetium (Lu). Particularly, the valence III ions of Pr, Nd, Sm, Eu, Tb, Dy, Ho, Er, Tm and Yb that can cause light emission of a level suitable for a phosphor in the present invention can be preferably employed.

Only one type of the aforementioned valence III rare earth ions may be employed, or two or more types of such valence III rare earth ions may be used for coactivating the base. By being coactivated with two or more types of valence III rare earth ions, the luminescent quantum efficiency can be improved by controlling the spectrum of absorption luminance minutely, and by the energy transfer from one type of rare earth ions to another type of rare earth ions. It is to be noted that, if the concentration of the valence III rare earth ions to be coactivated are substantially equal, the absorption light emission thereof will compete to reduce the overall luminescent quantum efficiency. Therefore, with regards to Sm, Eu, Tb and Tm that emit visible light critical in industry application at high efficiency, the occupying ratio of these elements, whether just one type or more than one type, is preferably at least 50% of the valence III rare earth ions in order to improve the luminescent quantum efficiency of the phosphor in the state of coactivation.

Second Metal Ions

The oxide crystal base of the phosphor of the present invention includes second metal ions, in addition to valence III metal ions qualified as the first metal ions set forth above. Metal ions of valence I, valence IV or valence V are preferably employed for the second metal ions. For example, Li, Na, K, Rb, Cs, Ti, Zr, Hf, V, Nb, Ta, Si, Ge, Sn, Pb, P, As, Sb, Bi, and the like can be enumerated. If valence II metal ions such as Mg, Ca, Sr and Ba of valence II is present as the second metal ions, the desired 4fⁿ orbital level transition light emission may not be achieved since the valence III rare earth ions qualified as the luminous body will be readily substituted reductively with valence II ions. One type, or a combination of two or more types of the second metal ions can be employed in the base.

As set forth above, the oxide crystal base includes at least two types of metal ions. In other words, the oxide crystal base includes at least the first metal ions and the second metal ion set forth above. By employing two or more types of metal ions, appropriate crystal distortion can be exhibited without degrading the crystallinity to allow improvement of the transition intensity.

The crystal structure of the phosphor is not particularly limited, and a perovskite structure, spinel structure, pyrochlore structure, garnet structure, and the like can be employed.

The structural metallic element and composition of the phosphor of the present invention can be confirmed with the fluorescent X-ray method, ICP emission spectrometry, electron probe microanalyzer, and the like. The crystal structure of the phosphor can be confirmed by X-ray diffraction. The valence III of the rare earth ion can be confirmed by the excitation emission spectrum of the phosphor. Further, substitution of valence III rare earth ions for valence III metal ions at the lattice site can be confirmed by analyzing the extend X-ray absorption fine structure (EXAFS).

The method of fabricating the phosphor of the present invention is not particularly limited, and can be produced by employing the methods such as solid phase synthetic process, liquid phase synthetic process, vapor phase synthetic method, and the like. Particularly, in order to maintain uniform crystallinity and cause appropriate lattice-substitution of the activating rare earth ions, the synthetic method realizing a non-equilibrium state is particularly preferable. If the liquid phase synthetic process is to be employed, the supercritical synthetic process or Glico thermal synthetic process is preferable. If the vapor phase synthesis is to be employed, HVPE (Hydride Vapor Phase Epitaxy), MBE (Molecular Beam Epitaxy), or the like is suitable.

The present invention will be described in further detail hereinafter based on examples. It is to be understood that the present invention is not limited thereto.

### EXAMPLE 1

### LiAlTiO₄:Eu³⁺ Phosphor

7.39 g of lithium carbonate (Li₂CO₃) having a purity of 99.99%, 10.20 g of aluminium oxide (Al₂O₃) having a purity of 99.99%, 16.00 g of titanium oxide (TiO₂) having a purity of 99.99%, and 0.4 g of europium oxide (Eu₂O₃) having a purity of 99.99% were measured and mixed in an automatic mortar mixer and baked at 1500° C. in the atmosphere for three hours. Then, the well known processing steps (grinding, classification, and rinsing) were applied to obtain a LiAlTiO₄:Eu³⁺ phosphor.

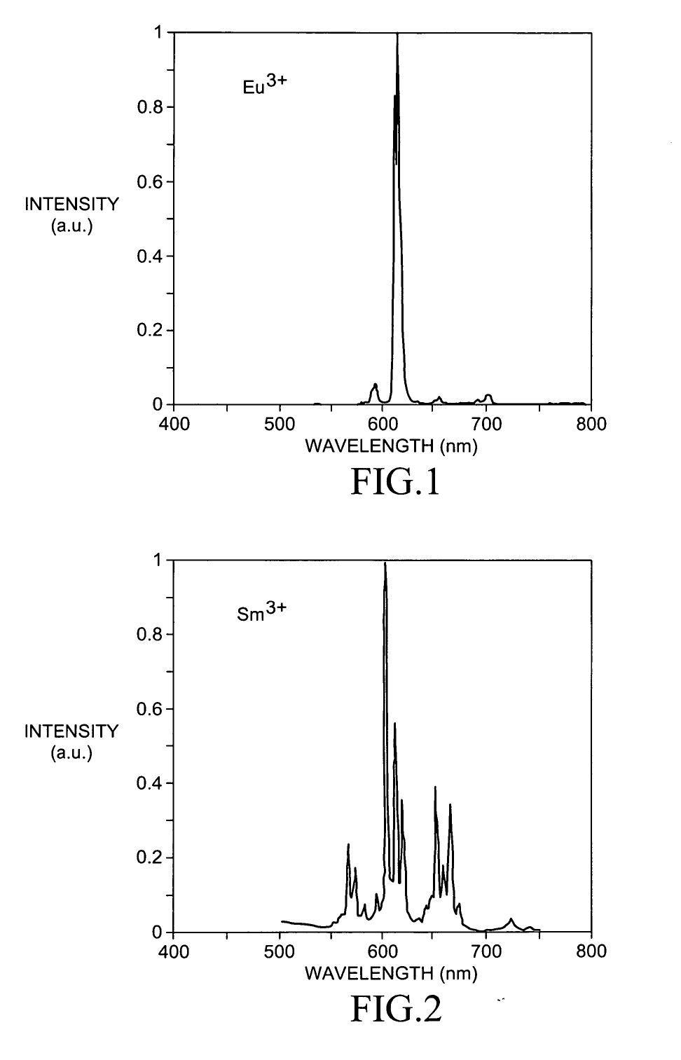

The emission spectrum of this phosphor is shown in FIG. 1. It was confirmed by the emission spectrum of FIG. 1 that the activating Eu corresponds to valence III ions to give off light. The presence of Li, Al, Ti, and Eu was confirmed by analyzing the component element of the phosphor by ICP emission spectrometry. It was also confirmed that the phosphor is LiAlTiO₄ having a spinel structure upon analyzing the crystal structure of the phosphor by X-ray diffraction. It was assumed that valence III Eu ions were lattice-substituted for valence III Al ion sites by analyzing the extend X-ray absorption fine structure (EXAFS). The luminescent quantum efficiency of the present phosphor was 60%.

### COMPARATIVE EXAMPLE 1

A phosphor was produced in a manner similar to that of Example 1, provided that a slight amount of yttrium oxide (Y₂O₃) was added. The luminescent quantum efficiency of the present phosphor was 30%, which is half that of Example 1. By X-ray diffraction and evaluation of the extend X-ray absorption fine structure, it was assumed that this phosphor is Li (Al, Y) TiO₄ and valence III Eu ions were lattice-substituted for valence III Y ion sites in priority.

### EXAMPLE 2

### ScAlO₃:Sm³⁺ Phosphor

13.80 g of scandium oxide (Sc₂O₃) having a purity of 99.99%, 10.20 g of aluminium oxide (Al₂O₃) having a purity of 99.99%, and 0.07 g of samarium oxide (Sm₂O₃) having a purity of 99.99% were measured and mixed in an automatic mortar mixer, and baked for three hours at 1700° C. in the atmosphere. Then, the well known processing steps (grinding, classification, and rinsing) were applied to obtain a ScAlO₃:Sm³⁺ phosphor.

The emission spectrum of the present phosphor is shown in FIG. 2. It was confirmed by the emission spectrum of FIG. 2 that the activating Sm corresponds to valence III ions to give off light. The presence of Sc, Al, and Sm was confirmed by analyzing the component element of the phosphor by ICP emission spectrometry. It was also confirmed that the phosphor is ScAlO₃ having a perovskite structure upon analyzing the crystal structure of the phosphor by X-ray diffraction. It was assumed that valence III Sm ions were lattice-substituted mainly for valence III Sc ion sites by analyzing the extend X-ray absorption fine structure (EXAFS). The luminescent quantum efficiency of the present phosphor was 55%.

### COMPARATIVE EXAMPLE 2

A phosphor was produced in a manner similar to that of Example 2, provided that 30 g of strontium carbonate (SrCO₃) was employed instead of scandium oxide (Sc₂O₃). The luminescent quantum efficiency of the present phosphor was 30%, which is approximately half of that of Example 2. Measurement of the emission spectrum showed a spectrum different from that of the phosphor of Example 2. It was assumed, by X-ray diffraction and analyzing the extend X-ray absorption fine structure, that the phosphor of Comparative Example 2 is SrAl₂O₄ and valence II Sm ions were lattice-substituted for valence II Sr ions.

### EXAMPLE 3

### ScTaO₇:Tb³⁺ Phosphor

13.80 g of scandium oxide (Sc₂O₃) having a purity of 99.99%, 44.18 g of tantalum pentoxide (Ta₂O₅) having a purity of 99.99%, and 0.15 g of terbium oxide (Tb₄O₇) having a purity of 99.99% were measured and mixed in an automatic mortar mixer, and baked at 1700° C. for three hours in the atmosphere. Then, the well known processing steps (grinding, classification, and rinsing) were applied to obtain ScTaO₇:Tb³⁺ phosphor.

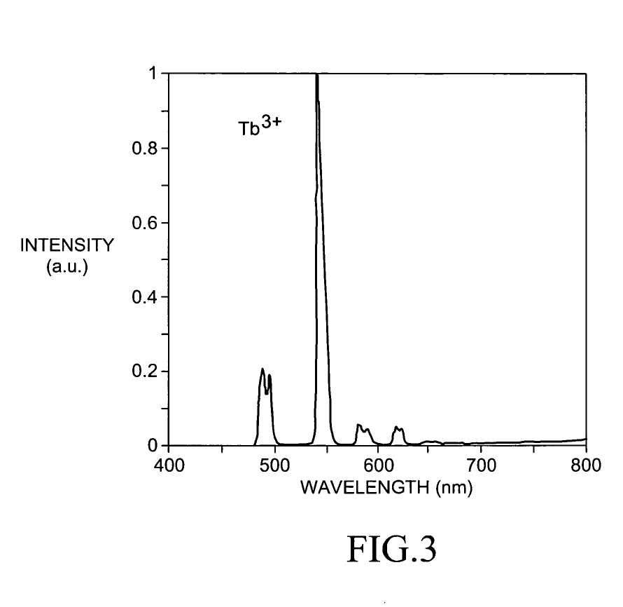

The emission spectrum of this phosphor is shown in FIG. 3. It was confirmed by the emission spectrum of FIG. 3 that the activating Tb corresponds to valence III ions to give off light. The presence of Sc, Ta, and Tb was confirmed by analyzing the component element of the phosphor by ICP emission spectrometry. It was also confirmed that the phosphor is ScTaO₇ having a pyrochlore structure upon analyzing the crystal structure of the phosphor by X-ray diffraction. It was assumed that valence III Tb ions were lattice-substituted for valence III Sc ion sites by analyzing the extend X-ray absorption fine structure (EXAFS). The luminescent quantum efficiency of the present phosphor was 60%.

### COMPARATIVE EXAMPLE 3

A phosphor was produced in a manner similar to that of Example 3, provided that 32.58 g of lanthanum oxide (La₂O₃) was employed instead of scandium oxide (Sc₂O₃). The luminescent quantum efficiency of the present phosphor was 30%, which is approximately half of that of Example 3. It was assumed that the phosphor of Comparative Example 3 is LaTaO₇, and valence III Tb ions were lattice-substituted for valence III La ion sites in priority, by X-ray diffraction and analyzing the extend X-ray absorption fine structure.

### EXAMPLE 4

### Mn₃Al₂Si₃O₁₂:Sm³⁺ Phosphor

26.08 g of manganese dioxide (MnO₂) having a purity of 99.99%, 10.2 g of aluminium oxide (Al₂O₃) having a purity of 99.99%, 18.03 g of silicon dioxide (SiO₂) having a purity of 99.99%, and 0.07 g of samarium oxide (Sm₂O₃) having a purity of 99.99% were measured and mixed in an automatic mortar mixer, and baked for three hours at 1600° C. in the atmosphere. Then, the well known processing steps (grinding, classification, and rinsing) were applied to obtain a Mn₃Al₂Si₃O₁₂:Sm³⁺ phosphor.

Upon measuring the emission spectrum of the present phosphor, an emission spectrum identical to that shown in FIG. 2 was obtained. It was confirmed that the activating Sm corresponds to valence III ions to give off light. The presence of Mn, Al, Si, and Sm was confirmed by analyzing the component element of the phosphor by ICP emission spectrometry. It was also confirmed that the phosphor is Mn₃Al₂Si₃O₁₂ having a garnet structure upon analyzing the crystal structure of the phosphor by X-ray diffraction. It was assumed that valence III Sm ions were lattice-substituted for valence III Al ion sites by analyzing the extend X-ray absorption fine structure (EXAFS). The luminescent quantum efficiency of the present phosphor was 30%.

### COMPARATIVE EXAMPLE 4

A phosphor was produced in a manner similar to that of Example 4, provided that a slight amount of yttrium oxide (Y₂O₃) was added. The luminescent quantum efficiency of the present phosphor was 10%, which is ⅓ of Example 4. By X-ray diffraction and evaluation of the extend X-ray absorption fine structure, the phosphor of Comparative Example 4 is Mn₃ (Al, Y)₂Si₃O₁₂, and it was assumed that valence III Sm ions were lattice-substituted for valence III Y ion sites in priority.

### EXAMPLE 5

### Mn₃Al₂Si₃O₁₂:Sm³⁺, Eu³⁺ Phosphor, and the Like

Mn₃Al₂Si₃O₁₂:Sm³⁺, Eu³⁺ phosphor was obtained in a manner similar to that of Example 4, provided that the added amount of samarium oxide (Sm₂O₃) and europium oxide (Eu₂O₃) was 0.06 g and 0.01 g, respectively. Furthermore, phosphors were produced in a manner similar to that of Example 4, having 0.01 g of each of Pr₂O₃, Tb₂O₃, Er₂O₃ or Yb₂O₃ adding, instead of europium oxide (EU₂O₃).

The luminescent quantum efficiency of the five phosphors set forth above was 40% (Eu₂O₃ added), 35% (Pr₂O₃ added), 33% (Tb₂O₃ added), 32% (Er₂O₃ added), and 30.5% (Yb₂O₃ added), exhibiting the improvement of approximately 30%, 20%, 10%, 5%, and 3%, respectively, as compared to the phosphor of Example 4.

### EXAMPLE 6

Mn₃Al₂Si₃O₁₂: Sm³⁺, Eu³⁺ phosphor was obtained in a manner similar to that of Example 4, provided that the added amount of samarium oxide (Sm₂O₃) and europium oxide (Eu₂O₃) was 0.035 g and 0.35 g, respectively. Furthermore, phosphors were produced in a manner similar to that of Example 4, having 0.01 g of each of Pr₂O₃, Tb₂O₃, Er₂O₃ or Yb₂O₃ adding, instead of europium oxide (Eu₂O₃).

The luminescent quantum efficiency of the five phosphors set forth above was 27% (EU₂O₃ added), 25.5% (Pr₂O₃ added), 25.5% (Tb₂O₃ added), 24% (Er₂O₃ added), and 24% (Yb₂O₃ added), respectively, higher as compared to the phosphor of Comparative Example 4, but lower by approximately 10%, 15%, 15%, 20% and 20%, respectively, as compared to the phosphor of Example 4.

Various measurements carried out for evaluating the properties of the above-described phosphors were carried out under the conditions set forth below.

(1) Measurement of Emission Spectrum: Spectro Photofluorometer FluoroMax-3, product by HORIBA, Ltd.

(2) X-ray Diffraction: Powder X-ray Diffraction Measurement Apparatus MPX18, product by Mac Science.

(3) Luminescent Quantum Efficiency: Fluorescence Measurement System, product by Otsuka Electronics Co., Ltd.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A phosphor with oxide crystal containing at least first metal ions and second metal ions as a base, wherein
said first metal ions include at least one type of valence III metal ions selected from the group consisting of aluminium, gallium, vanadium, scandium, antimony and indium,
said valence III metal ions are partially substituted with at least one type of valence III rare earth ions qualified as a luminous body,
said second metal ions are metal ions other than valence II metal ions.

2. The phosphor according to claim 1, wherein said second metal ions include metal ions of valence I, valence IV or valence V.

3. The phosphor according to claim 1, wherein said valence III rare earth ions include at least one type of rare earth ions selected from the group consisting of praseodymium, neodymium, samarium, europium, terbium, dysprosium, holmium, erbium, thulium, and yttribium.

4. The phosphor according to claim 3, wherein an occupying ratio of any one of europium, samarium, terbium, and thulium in said valence III rare earth ions is at least 5.0% to a total number of atoms of said valence III rare earth ions.
